(19) United States
(12) Patent Application Publication
(10) Pub. No.: US 2024/0018990 A1
(43) Pub. Date: Jan. 18, 2024

(54) Compensation Nut Assembly

(71) Applicant: Illinois Tool Works Inc., Glenview, IL (US)

(72) Inventor: Weibin LIU, Shanghai (CN)

(21) Appl. No.: 18/222,701

(22) Filed: Jul. 17, 2023

(30) Foreign Application Priority Data
Jul. 18, 2022 (CN) 202210839442X
Jun. 30, 2023 (CN) 2023108004315

(51) Int. Cl. F16B 33/02

(52) U.S. Cl. CPC F16B 33/02

(57) ABSTRACT

The present disclosure provides a compensation nut assembly comprising a first nut having a limiting tab, a second nut and a limiting member connected to the second nut and comprising a first blocking arm and a second blocking arm. When the assembly is in a pre-assembled state, the first and second blocking arms retain the limiting tab therebetween in a circumferential direction. When a certain screwing force is applied to the first nut in the pre-assembled state in a first rotation direction, the first and second blocking arms are at least partially deflected by the limiting tab to allow the first nut to rotate out of the pre-assembled state. When a certain screwing force is applied to the first nut in the pre-assembled state in a second rotation direction, the first and second blocking arms restrict the first nut from rotating out of the pre-assembled state.

### RELATED APPLICATION

The present application claims the benefit of Chinese Patent Application Nos. 202210839442X, filed Jul. 18, 2022 and 2023108004315, filed Jun. 30, 2023, each titled “Compensation Nut Assembly;” the contents of which are hereby incorporated by reference.

### BACKGROUND

In various industrial applications (e.g., automobile industry), components are connected together by using fasteners. In some applications, there may be a gap between components. For example, two panels may be separated from each other by a gap area or a gap. The fasteners need to maintain the gap between the two panels while fastening the two panels, so as to prevent the panels from collapsing. In light of the above, a need exists for a compensation nut assembly that is adjustable.

### SUMMARY

The present disclosure relates generally to an improved fastener, substantially as illustrated by and described in connection with at least one of the figures, as set forth more completely in the claims. More specifically, the present disclosure relates to a compensation nut assembly for securing two components together that is adjustable in length in an axial direction.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is an exploded view of a compensation nut assembly according to an embodiment of the present disclosure.

FIG. 2A is a perspective view of a limiting member of the compensation nut assembly shown in FIG. 1 from a first perspective.

FIG. 2B is a perspective view of the limiting member of the compensation nut assembly shown in FIG. 1 from a second perspective.

FIG. 3A is a perspective view of the compensation nut assembly shown in FIG. 1 in a pre-assembled state.

FIG. 3B is a perspective view of the compensation nut assembly shown in FIG. 1 in a first state during a fastening operation.

FIG. 3C is a perspective view of the compensation nut assembly shown in FIG. 1 in a second state during a fastening operation.

FIG. 3D is a perspective view of the compensation nut assembly shown in FIG. 1 in a third state during a fastening operation.

FIG. 4 is a perspective view of the compensation nut assembly shown in FIG. 1 in a fastened state.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

In one example, the compensation nut assembly comprises a first nut, a second nut and a limiting member. The first nut comprises a limiting tab extending from an outer surface thereof. The second nut is in threaded connection with the first nut. The first nut is configured to be rotatable about an axis relative to the second nut in a first rotation direction to increase a length of the compensation nut assembly along the axis and to be rotatable in a second rotation direction opposite to the first rotation direction relative to the second nut to reduce the length of the compensation nut assembly along the axis. The limiting member is connected to the second nut and comprises a first blocking arm and a second blocking arm. When the compensation nut assembly is in a pre-assembled state, the first blocking arm and the second blocking arm retain the limiting tab of the first nut therebetween in a circumferential direction to maintain the length of the compensation nut assembly within a predetermined range. When a certain screwing force is applied to the first nut in the pre-assembled state in the first rotation direction, as the first nut is rotated, the first blocking arm and the second blocking arm are at least partially deflected under the action of the limiting tab of the first nut to allow the first nut to rotate in a direction away from the second nut and out of the pre-assembled state. When a certain screwing force is applied to the first nut in the pre-assembled state in the second rotation direction, the first blocking arm and the second blocking arm restrict the first nut from rotating out of the pre-assembled state. For example, when the compensation nut assembly is in the pre-assembled state, in the first rotation direction, the first blocking arm is in front of the limiting tab and the second blocking arm is behind the limiting tab.

The second blocking arm may comprise a longitudinal arm extending substantially along the axis and a transverse arm extending from the longitudinal arm towards the first blocking arm. The transverse arm comprises a blocking face provided at a free distal end thereof and an operating face provided on the top thereof. The blocking face faces the first blocking arm. The operating face extends at an angle relative to the axis in a direction away from the first blocking arm towards the longitudinal arm. For example, the first blocking arm extends substantially along the axis. The first blocking arm has a thickness less than the thickness of the longitudinal arm of the second blocking arm.

The operating face can be connected with the blocking face at one end thereof. In some examples, the operating face forms a part of a surface of the top of the transverse arm. In some examples, the longitudinal arm extends in a circumferential direction. In some examples, the limiting member further comprises a connecting ring. The first blocking arm and the second blocking arm are provided on the connecting ring. The connecting ring is sleeved on the second nut. In some examples, a lower portion of the first blocking arm is widened to increase the strength of the first blocking arm. In some examples, the first nut comprises a shaft and a collar provided at one end of the shaft. The limiting tab protrudes radially from the collar.

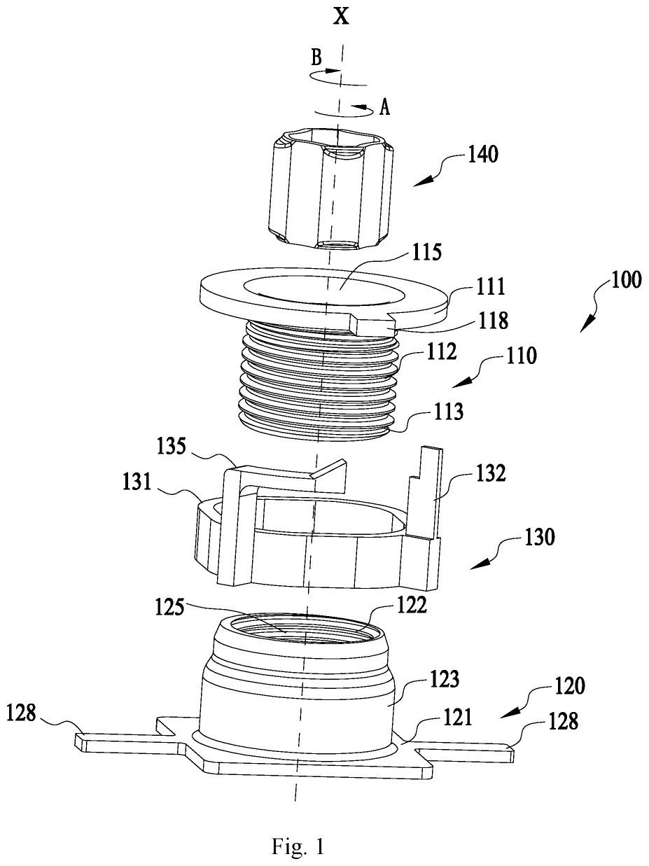

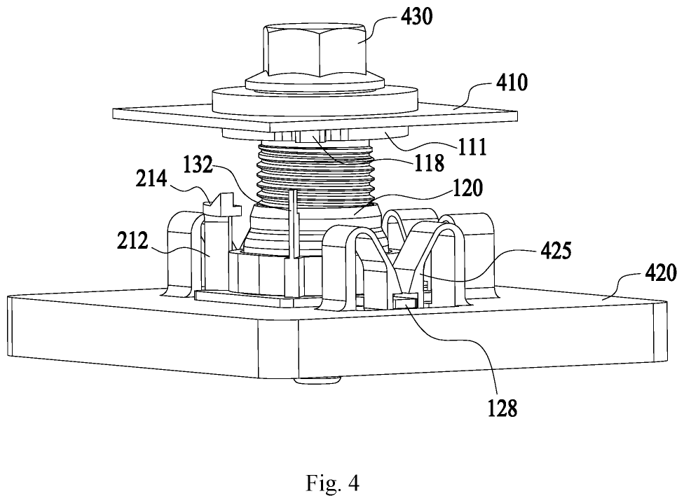

FIG. 1 is an exploded view of a compensation nut assembly 100 according to an embodiment of the present disclosure. The compensation nut assembly 100 cooperates with a bolt 430 to secure a first component 410 and a second component 420 (see FIG. 4) together. The first component 410 and the second component 420 may be connected together with a slightly variable distance, and the distance separating them needs to be maintained by the compensation nut assembly 100. In use, the compensation nut assembly 100 is arranged between the first component 410 and the second component 420. The compensation nut assembly 100 may be used, for example, in a motor vehicle, where the first component 410 is, for example, a supporting structure for a dashboard, and the second component 420 is, for example, a vehicle structure.

As shown in FIG. 1, the compensation nut assembly 100 has an axis X and includes a first nut 110, a second nut 120, a limiting member 130, and a bushing 140. The first nut 110 and the second nut 120 are made of metal, the limiting member 130 is made of plastics and the bushing 140 is made of elastomeric rubber or soft plastics.

The second nut 120 is fixedly connected to the second component 420. The first nut 110 is in threaded connection with the second nut 120 and rotatable about the axis X relative to the second nut 120 in a first rotation direction A away from the second nut 120, or rotatable in a second rotation direction B opposite to the first rotation direction A towards the second nut 120.

The bushing 140 is arranged inside the first nut 110, and the bushing 140 is connected to the first nut 110 by friction to limit axial and circumferential movement of the bushing 140 relative to the first nut 110.

The limiting member 130 is connected to the second nut 120 and is used for maintaining the first nut 110 and the second nut 120 in a pre-assembled state while allowing the first nut 110 to be rotated from the pre-assembled state to a fastened state.

Still as shown in FIG. 1, the first nut 110 includes a shaft 113 and a collar 111 provided at one end of the shaft 113. The first nut 110 further includes an external thread 112 provided on an outer surface of the shaft 113 and a first channel 115 running through the collar 111 and the shaft 113. The first nut 110 is in threaded connection with the second nut 120 by the external thread 112, and the first channel 115 is used for receiving the bushing 140. The collar 111 has an outer diameter greater than the outer diameter of the shaft 113 and is formed by protruding from the outer surface of the shaft 113 and extending around the shaft 113. The first nut 110 further includes a limiting tab 118. The limiting tab 118 is formed by protruding outwards from an outer peripheral surface of the collar 111.

The second nut 120 includes a shaft 123 and a collar 121 provided at one end of the shaft 123. The second nut 120 further includes a second channel 125 running through the collar 121 and the shaft 123, and an internal thread 122 provided on an inner wall of the second channel 125. The second channel 125 is configured for receiving the first nut 110. The first nut 110 is in threaded connection with the second nut 120 by means of engagement between the internal thread 122 and the external thread 112. The collar 121 has an outer diameter greater than the outer diameter of the shaft 123 and is formed by protruding from the outer surface of the shaft 123 and extending around the shaft 123. The collar 121 further includes a plurality of connecting bars 128 to connect the second nut 120 to the second component 420.

When the first nut 110 is in threaded connection with the second nut 120, the first nut 110 is rotatable in the first rotation direction A relative to the second nut 120 to move away from the second nut 120, and rotatable in the second rotation direction B opposite to the first rotation direction A relative to the second nut 120 to move towards the second nut 120. That is to say, the compensation nut assembly 100 is adjustable in length in the axial direction X. When the first nut 110 is rotated in the first rotation direction A relative to the second nut 120, a distance between the collar 111 of the first nut 110 and the collar 121 of the second nut 120 is increased so that the length of the compensation nut assembly 100 in the axial direction X is increased. When the first nut 110 is rotated in the second rotation direction B relative to the second nut 120, the distance between the collar 111 of the first nut 110 and the collar 121 of the second nut 120 is reduced so that the length of the compensation nut assembly 100 along the axial direction X is reduced.

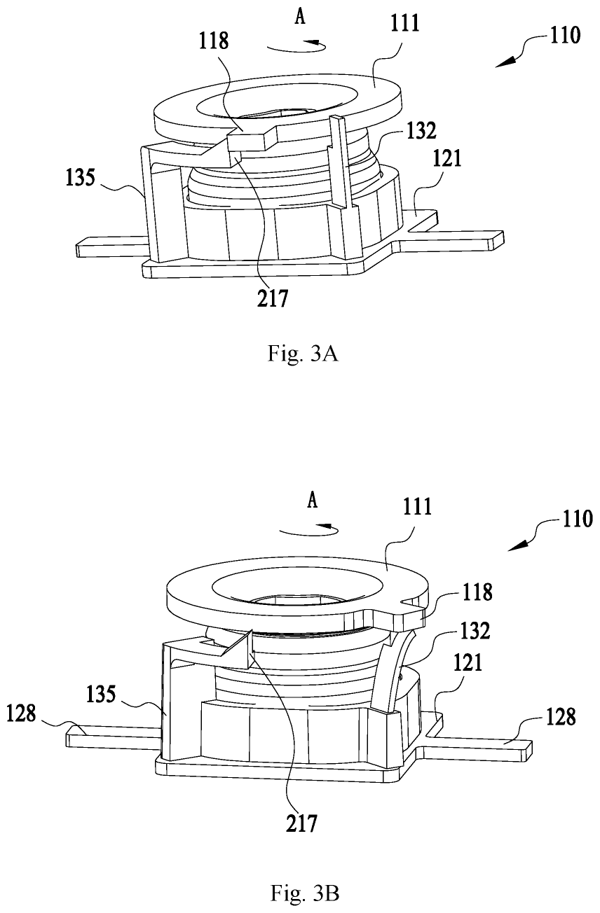

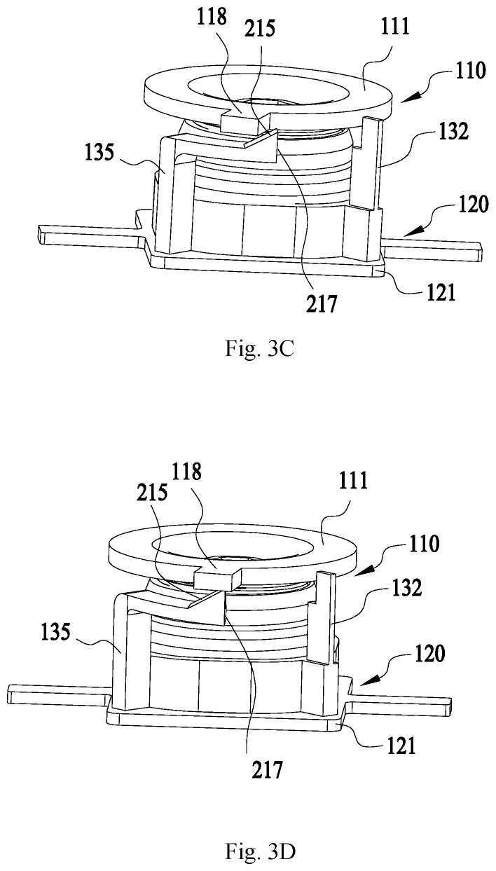

The bolt 430 (see FIG. 4) applies a screwing force to the first nut 110 through the bushing 140, causing the first nut 110 to rotate relative to the second nut 120 between the pre-assembled state (as shown in FIG. 3A) and the fastened state (as shown in FIG. 4). In the pre-assembled state, the compensation nut assembly 100 has a length within a predetermined range, such that the compensation nut assembly 100 is easy to store and transport and can be placed between the first component 410 and the second component 420 (as shown in FIG. 4). In order to reach a fastened state from the pre-assembled state, the first nut 110 needs to be rotated away from the second nut 120 to increase the length of the compensation nut assembly 100. By increasing the length of the compensation nut assembly 100, the collar 111 of the first nut 110 is allowed to be in contact with the first component 410 spaced apart from the second component 420 by a predetermined gap, such that when the bolt 430 cooperates with the compensation nut assembly 100 to fasten the first member to the second member, the predetermined gap between the first component 410 and the second component 420 can be maintained via the compensation nut assembly 100 to prevent the first component 410 from collapsing during a fastening operation.

The limiting member 130 includes a connecting ring 131 and a first blocking arm 132 and a second blocking arm 135 provided on the connecting ring 131. The connecting ring 131 is sleeved on the shaft 123 of the second nut 120 and connects the limiting member 130 to the second nut 120 by interference fit, for example. The first blocking arm 132 and the second blocking arm 135 are configured to cooperate with the limiting tab 118 of the first nut 110 between the first blocking arm 132 and the second blocking arm 135 to retain the first nut 110 in a predetermined rotation position relative to the second nut 120, thereby maintaining the compensation nut assembly 100 in the pre-assembled state. Furthermore, the first blocking arm 132 and the second blocking arm 135 are further configured such that when the compensation nut assembly 100 is in the pre-assembled state, the first blocking arm 132 and the second blocking arm 135 allow the first nut 110 to be screwed in the first rotation direction A for performing the fastening (or mounting) operation, but restrict the first nut 110 from being screwed in the second rotation direction B.

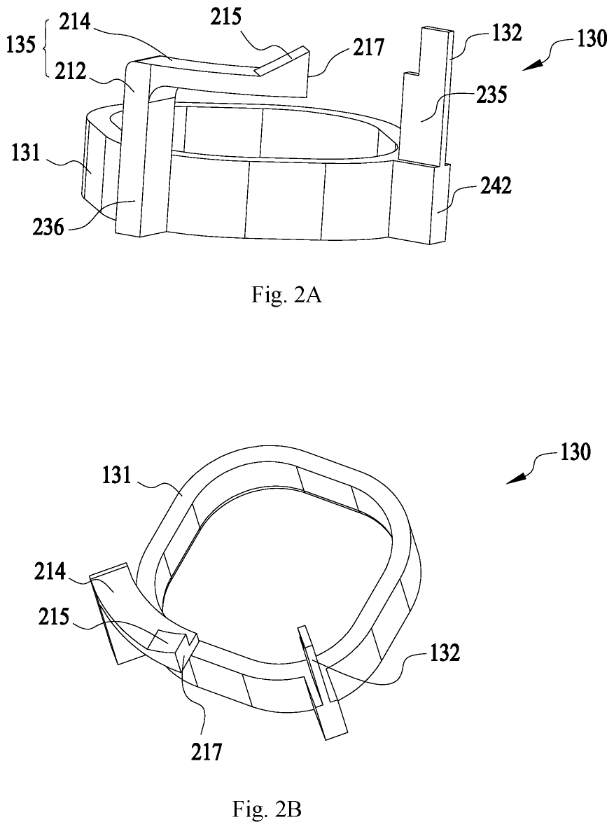

FIGS. 2A and 2B show the specific structure of the limiting member 130, wherein FIG. 2A is an enlarged perspective view of the limiting member 130 from a first perspective, and FIG. 2B is an enlarged perspective view of the limiting member 130 from a second perspective. The limiting member 130 is integrally formed of a plastic material. As shown in FIGS. 2A and 2B, the first blocking arm 132 extends substantially in the axial direction X and is flexible, and accordingly can be deflected when subjected to a force and can return to its initial position when the force is withdrawn. The first blocking arm 132 is connected to the connecting ring 131 by a first connecting portion 242. The first connecting portion 242 has a thickness greater than the thickness of the first blocking arm 132. When a force applied to the first blocking arm 132 by the limiting tab 118 on the first nut 110 reaches a certain level, the limiting tab 118 enables the first blocking arm 132 to be deflected and moves over the first blocking arm 132. A lower portion 235 of the first blocking arm 132 is widened, such that the strength of the first blocking arm 132 can be ensured by widening the lower portion 235 even if the first blocking arm 132 is thin.

The second blocking arm 135 is generally L-shaped and includes a longitudinal arm 212 and a transverse arm 214. The longitudinal arm 212 is connected to the connecting ring 131 and extends substantially in the axial direction X (see FIG. 1). The transverse arm 214 extends from the longitudinal arm 212 towards the first blocking arm 132. One end of the transverse arm is connected to the longitudinal arm 212 and another end thereof forms a free distal end of the second blocking arm 135. As shown in FIG. 2A, the longitudinal arm 212 is connected to the connecting ring 131 by a second connecting portion 236. The longitudinal arm 212 has a thickness approximately the same as the thickness of the second connecting portion 236, but the thickness of the longitudinal arm 212 is greater than the thickness of the first blocking arm 132. Therefore, the longitudinal arm 212 of the second blocking arm 135 cannot be deflected, but the transverse arm 214 of the second blocking arm 135 can be deflected relative to the longitudinal arm 212 and can return to its initial position due to its resilience.

Still as shown in FIGS. 2A and 2B, the second blocking arm 132 includes a blocking face 217 provided at its free distal end, and an operating face 215 provided on its top. The blocking face 217 faces the first blocking arm 132 and extends substantially along the axis X (see FIG. 1). The operating face 215 forms a part of the top surface of the blocking face 217, and the operating face 215 extends at an angle relative to the axis (X) in a direction away from the blocking face 217 towards the longitudinal arm 212. One end of the operating face 215 is connected with the blocking face 217. As can be seen in FIG. 2B, the operating face 215 is formed by a triangular block provided on the top of the transverse arm 214. In addition, as can be seen in FIG. 2B, the transverse arm 214 extends substantially in a circumferential direction. The transverse arm 214 of the second blocking arm 135 cannot be deflected relative to the longitudinal arm 212 when the second blocking arm 132 is subjected to a force applied to the blocking face 217. However, the transverse arm 214 of the second blocking arm 135 can be deflected relative to the longitudinal arm 212 when the second blocking arm 132 is subjected to a force applied to the operating face 215.

In some embodiments, an angle spanned in the direction of rotation (the circumferential direction) between the first blocking arm 132 and the blocking face 217 of the second blocking arm 135 is less than 90°.

The first blocking arm 132 and the second blocking arm 135 of the compensation nut assembly 100 of the present disclosure are configured such that: when the compensation nut assembly 100 is in a pre-assembled state, the first blocking arm 132 and the second blocking arm 135 retain the limiting tab 118 of the first nut 110 between the first blocking arm 132 and the second blocking arm 135 in the circumferential direction to maintain the length of the compensation nut assembly 100 within the predetermined range; when a certain screwing force is applied to the first nut 110 in the pre-assembled state in the first rotation direction A, as the first nut 110 is rotated, the first blocking arm 132 and the second blocking arm 135 are at least partially deflected under the action of the limiting tab 118 of the first nut 110 to allow the first nut 110 to rotate in a direction away from the second nut 120 and out of the pre-assembled state; and when a certain screwing force is applied to the first nut 110 in the pre-assembled state in the second rotation direction B, the first blocking arm 132 and the second blocking arm 135 restrict the first nut 110 from rotating out of the pre-assembled state. The certain screwing force means that the force applied by the operator to the first nut 110 allows the first nut 110 to move axially relative to the second nut 120 as it engages with the threads of the second nut 120, but does not disrupt the threaded engagement therebetween and does not disrupt the second stop arm 135.

In other words, when the compensation nut assembly 100 is maintained in the pre-assembled state by the first blocking arm 132 and the second blocking arm 135, the first nut 110 can be rotated from the pre-assembled state to the fastened state only by applying a certain screwing force in the first rotation direction A to the first nut 110. Therefore, if an attempt is made to screw the first nut 110 in the second rotation direction B for fastening by mistake, the second blocking arm 135 blocks the first nut 110 to restrict the first nut 110 from rotating from the pre-assembled state to the fastened state.

FIGS. 3A to 3D and FIG. 4 show various states of the compensation nut assembly 100. FIG. 3A is a perspective view of the compensation nut assembly 100 in the pre-assembled state, FIG. 3B is a perspective view of the compensation nut assembly 100 in a first state during a fastening operation, FIG. 3C is a perspective view of the compensation nut assembly 100 in a second state during a fastening operation, FIG. 3D is a perspective view of the compensation nut assembly 100 in a third state during a fastening operation, and FIG. 4 is a perspective view of the compensation nut assembly 100 in a fastened state. The first component 410 and the second component 420 which are connected by the compensation nut assembly 100 are not shown in FIGS. 3B to 3D.

The compensation nut assembly 100 is required to be maintained within a predetermined length range before being mounted (or fastened), for example, during transportation, such that an operator can place the compensation nut assembly 100 in an expected mounting position (i.e., in the gap between the two components to be mounted). This state is referred as the pre-assembled state of the compensation nut assembly 100. As described above, the length of the compensation nut assembly 100 is determined by the distance between the collar 111 of the first nut 110 and the collar 121 of the second nut 120. As the first nut 110 is in threaded connection with the second nut 120, it is not possible to retain the first nut 110 in the desired rotation position relative to the second nut 120 if no additional retaining force is applied to the first nut 110, and thus it is also not possible to ensure that the length of the compensation nut assembly 100 is within the predetermined range.

The first blocking arm 132 and the second blocking arm 135 of the limiting member 130 of the present disclosure are capable of cooperating with the limiting tab 118 of the first nut 110 to maintain the length of the compensation nut assembly 100 within the predetermined range.

Specifically, when the compensation nut assembly 100 is in the pre-assembled state shown in FIG. 3A, the limiting tab 118 of the first nut 110 is located between the first blocking arm 132 and the blocking face 217 of the second blocking arm 135 of the limiting member 130. In the first rotation direction A, the first blocking arm 132 is in front of the limiting tab 118, and the second blocking arm 135 is behind the limiting tab 118.

When no certain screwing force for the screwing operation is applied to the first nut 110, the limiting tab 118 of the first nut 110 cannot move over the first blocking arm 132, even though the first nut 110 may be rotated in the first rotation direction A relative to the second nut 120 (e.g., due to vibrations during transportation), because the first blocking arm 132, despite its resilience, needs to be subjected to a certain force in order to deflect. In this case, as a result, the limiting tab 118 of the first nut 110 cannot move over the first blocking arm 132. In addition, when the first nut 110 is rotated in the second rotation direction B relative to the second nut 120 (e.g., due to vibrations during transportation), the limiting tab 118 of the first nut 110 is blocked by the blocking face 217 and cannot deflect the transverse arm 135 of the second blocking arm 135 to move over the second blocking arm 135, such that the limiting tab 118 is retained between the first blocking arm 132 and the blocking face 217 of the second blocking arm 135, thereby maintaining the length of the compensation nut assembly 100 within the predetermined range.

As shown in FIG. 3B, when the first component 410 and the second component 420 (shown in FIG. 4) are connected by the compensation nut assembly 100, first, the compensation nut assembly 100 needs to be placed between the first component 410 and the second component 420 and the second nut 120 is connected to the second component 420 by means of the connecting bars 128. The bolt 430 (see FIG. 4), which fits with the compensation nut assembly 100, is then inserted into the bushing 140 for fastening.

As the operator screws the bolt 430, the bolt 430 drives the first nut 110 through the bushing 140 to make the first nut 110 to rotate relative to the second nut 120 in the first rotation direction A so as to move away from the second nut 120. Under the screwing force applied by the bolt 430, the limiting tab 118 of the first nut 110 deflects the first blocking arm 132 and moves over the first blocking arm 132, and then rotates towards the operating face 215 of the second blocking arm 135.

When the limiting tab 118 of the first nut 110 is rotated to come into contact with the operating face 215 of the second blocking arm 135 (as shown in FIG. 3C), as the first nut 110 continues to rotate, the limiting tab 118 of the first nut 110 forces the transverse arm 214 of the second blocking arm 135 to deflect downwards (as shown in FIG. 3D), thereby blocking of the limiting tab 118 by the second blocking arm 135 is eliminated. This allows the limiting tab 118 of the first nut 110 to move over the second blocking arm 135 and continue to rotate in the first rotation direction A.

As the first nut 110 moves upwards in the axial direction (i.e., moves away from the second nut 120) by means of further screwing, the limiting tab 118 of the first nut 110 gradually moves above the operating face 215 of the second blocking arm 135 and is no longer in contact the operating face 215. When the collar 111 of the first nut 110 abuts against the first component 410, the first nut 110 does not further move upwards in the axial direction (i.e., moves away from the second nut 120).

As shown in FIG. 4, the first component 410 and the second component 420 are fastened together by the compensation nut assembly 100 and the bolt 430, where the second nut 120 is fixedly connected to the second component 420 by means of the cooperation between the connecting bars 128 and elastic connecting members 425 provided on the second component 420. When the compensation nut assembly 100 is in the fastened state as described in FIG. 4, the length of the compensation nut assembly 100 is not further increased and the compensation nut assembly 100 is fastened by the bolt 430 and the length cannot be reduced either. As a result, the compensation nut assembly 100 can maintain the distance between the first component 410 and the second component 420.

Typically, the distance (i.e., pitch) by which the first nut 110 moves relative to the second nut 120 in the axial direction by one revolution is very small, e.g., about 1 mm. As a result, it is difficult to achieve that the limiting tab of the first nut is blocked by the second blocking arm in the pre-assembled state, while the limiting tab of the first nut is moved above the second blocking arm and is not in contact with the second blocking arm after the first nut is moved up one pitch by screwing. According to the present disclosure, the second blocking arm is configured to have a longitudinal arm and a transverse arm and to have a blocking face at its free distal end and an inclined operating face on its top, the transverse arm of the second blocking arm may be deflected downwards when subjected to a force from behind in the first rotation direction A, thereby eliminating the blocking of the limiting tab of the first nut. The second blocking arm of the present disclosure can also prevent the operator from screwing the first nut in the pre-assembled state in an incorrect direction during the fastening operation. Therefore, according to the present disclosure, it is possible to maintain the length of the compensation nut assembly in the pre-assembled state within the predetermined range, and the mounting (fastening) of the compensation nut assembly is also facilitated.

Although the present disclosure is described with respect to the examples of the embodiments outlined above, various alternatives, modifications, variations, improvements, and/or substantial equivalents that are known or current or to be anticipated later may be apparent to those of at least ordinary skill in the art. Furthermore, the technical effects and/or technical problems described in this description are exemplary rather than limiting; therefore, the disclosure in this description may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or substantial equivalents.

1. A compensation nut assembly (100) for securing two components together, the compensation nut assembly (100) comprising:
a first nut (110) comprising a limiting tab (118) extending from an outer surface thereof;
a second nut (120) being in threaded connection with the first nut (110), wherein the first nut (110) is configured to be rotatable about an axis (X) relative to the second nut (120) in a first rotation direction (A) to increase a length of the compensation nut assembly along the axis (X) and to be rotatable in a second rotation direction (B) opposite to the first rotation direction (A) relative to the second nut (120) to reduce the length of the compensation nut assembly along the axis (X); and
a limiting member (130) being connected to the second nut (120) and comprising a first blocking arm (132) and a second blocking arm (135), wherein the first blocking arm (132) and the second blocking arm (135) are configured such that:
when the compensation nut assembly (100) is in a pre-assembled state, the first blocking arm (132) and the second blocking arm (135) retain the limiting tab (118) of the first nut (110) therebetween in a circumferential direction to maintain the length of the compensation nut assembly (100) within a predetermined range;
when a certain screwing force is applied to the first nut (110) in the pre-assembled state in the first rotation direction (A), as the first nut (110) is rotated, the first blocking arm (132) and the second blocking arm (135) are at least partially deflected under an action of the limiting tab (118) of the first nut (110) to allow the first nut (110) to rotate in a direction away from the second nut (120) and out of the pre-assembled state; and
when a certain screwing force is applied to the first nut (110) in the pre-assembled state in the second rotation direction (B), the first blocking arm (132) and the second blocking arm (135) restrict the first nut (110) from rotating out of the pre-assembled state.

2. The compensation nut assembly (100) according to claim 1, wherein when the compensation nut assembly (100) is in the pre-assembled state, in the first rotation direction (A), the first blocking arm (132) is in front of the limiting tab (118) and the second blocking arm (135) is behind the limiting tab (118).

3. The compensation nut assembly (100) according to claim 2, wherein the second blocking arm (135) comprises a longitudinal arm (212) extending substantially along the axis (X) and a transverse arm (214) extending from the longitudinal arm (212) towards the first blocking arm (132), the transverse arm (214) comprising a blocking face (217) provided at a free distal end thereof and an operating face (215) provided on a top thereof, the blocking face (217) facing the first blocking arm (132), and the operating face (215) extending at an angle relative to the axis (X) in a direction away from the first blocking arm (132) towards the longitudinal arm (212).

4. The compensation nut assembly (100) according to claim 3, wherein the first blocking arm (132) extends substantially along the axis (X), and the first blocking arm (132) has a thickness less than the thickness of the longitudinal arm (212) of the second blocking arm (135).

5. The compensation nut assembly (100) according to claim 3, wherein the operating face (215) is connected with the blocking face (217) at one end thereof.

6. The compensation nut assembly (100) according to claim 3, wherein the operating face (215) forms a part of a surface of a top of the transverse arm (214).

7. The compensation nut assembly (100) according to claim 3, wherein the longitudinal arm (212) extends in a circumferential direction.

8. The compensation nut assembly (100) according to claim 2, wherein the limiting member (130) further comprises a connecting ring (131), wherein the first blocking arm (132) and the second blocking arm (135) are provided on the connecting ring (131), and the connecting ring (131) is sleeved on the second nut (120).

9. The compensation nut assembly (100) according to claim 4, wherein a lower portion of the first blocking arm (132) is widened to increase strength of the first blocking arm (132).

10. The compensation nut assembly (100) according to claim 1, wherein the first nut (110) comprises a shaft (113) and a collar (111) provided at one end of the shaft (113), wherein the limiting tab (118) protrudes radially from the collar (111).
